(19) United States
(12) Patent Application Publication
(10) Pub. No.: US 2015/0237356 A1
(43) Pub. Date: Aug. 20, 2015

(54) HOST ENCODER FOR HARDWARE-ACCELERATED VIDEO ENCODING

(71) Applicant: Microsoft Corporation, Redmond, WA (US)

(72) Inventors: Yongjun Wu, Bellevue, WA (US); Gary J. Sullivan, Bellevue, WA (US); Shyam Sadhwani, Bellevue, WA (US)

(73) Assignee: MICROSOFT CORPORATION, Redmond, WA (US)

(21) Appl. No.: 14/183,372

(22) Filed: Feb. 18, 2014

(51) Int. Cl. H04N 19/196; H04N 19/103; H04N 19/156; H04N 19/42; H04N 19/174

(52) U.S. Cl. CPC H04N 19/196; H04N 19/42; H04N 19/174; H04N 19/156; H04N 19/103

(57) ABSTRACT

By controlling decisions for high layers of bitstream syntax for encoded video, a host encoder provides consistent behaviors even when used with accelerator hardware from different vendors across different hardware platforms. For example, the host encoder controls high-level behaviors of encoding and sets values of syntax elements for sequence layer and picture layer of an output bitstream (and possibly other layers such as slice-header layer), while using only a small amount of computational resources. An accelerator that includes the accelerator hardware then controls encoding decisions for lower layers of syntax, in a manner consistent with the values of syntax elements set by the host encoder, setting values of syntax elements for the lower layers of syntax, which allows the accelerator some flexibility in making its encoding decisions.

### BACKGROUND

Engineers use compression (also called source coding or source encoding) to reduce the bit rate of digital video. Compression decreases the cost of storing and transmitting video information by converting the information into a lower bit rate form. Decompression (also called decoding) reconstructs a version of the original information from the compressed form. A “codec” is an encoder/decoder system.

Over the last two decades, various video codec standards have been adopted, including the ITU-T H.261, H.262 (MPEG-2 or ISO/IEC 13818-2), H.263 and H.264 (MPEG-4 AVC or ISO/IEC 14496-10) standards, the MPEG-1 (ISO/IEC 11172-2) and MPEG-4 Visual (ISO/IEC 14496-2) standards, and the SMPTE 421M (VC-1) standard. More recently, the HEVC standard (ITU-T H.265 or ISO/IEC 23008-2) has been approved. A video codec standard typically defines options for the syntax of an encoded video bitstream, detailing parameters in the bitstream when particular features are used in encoding and decoding. For example, a bitstream is organized hierarchically, as sequence-layer parameters for a sequence, picture-layer parameters for pictures of the sequence, slice-layer parameters for slices in a picture, and lower-layer parameters for blocks of a given picture. In many cases, a video codec standard also provides details about the decoding operations a decoder should perform to achieve conforming results in decoding. Aside from codec standards, various proprietary codec formats define other options for the syntax of an encoded video bitstream and corresponding decoding operations.

While some video encoding operations are relatively simple in terms of computational resources used by the operations, others are computationally complex. For example, motion estimation, frequency transforms, fractional sample interpolation, in-loop deblock filtering, color conversion, and video re-sizing can require extensive computation. This computational complexity can be problematic in various scenarios, such as encoding of high-quality, high-bit rate video (e.g., compressed high-definition video) or real-time encoding.

Thus, some encoders use hardware acceleration to offload certain computationally intensive operations to a graphics processor or other special-purpose hardware. For example, in some configurations, a computer system includes at least one primary central processing unit (“CPU”) as well as at least one graphics processing unit (“GPU”) or other hardware specially adapted for graphics processing or video encoding. A host encoder uses the primary CPU(s) to control overall encoding and uses the GPU(s) (or other special-purpose hardware) to perform operations that collectively require extensive computation, accomplishing acceleration of video encoding. In a typical architecture for hardware-accelerated video encoding, a host encoder controls overall encoding. The host encoder signals control information and data to a device driver for accelerator hardware.

In one existing architecture for hardware-accelerated video encoding, a hardware vendor provides a host encoder to work with that vendor's acceleration hardware. The host encoder exposes an interface through which an application can specify how the host encoder should control encoding. In many situations, host encoders from different vendors provide encoding that is not consistent with encoding behaviors specified by an application through the interface. In extreme cases, the application may be incompatible with hardware provided by a vendor.

### SUMMARY

In summary, the detailed description presents innovations in design and use of a host encoder for hardware-accelerated encoding. By controlling decisions for high layers of bitstream syntax for encoded media, the host encoder provides consistent behaviors even when used with accelerator hardware from different vendors across different hardware platforms.

The host encoder sets values of syntax elements of an output bitstream for at least one of sequence-layer syntax and picture-layer syntax for media. For example, the output bitstream includes one or more sequence parameter set (“SPS”) syntax structures indicating the values of syntax elements set by the host encoder for sequence-layer syntax as well as one or more picture parameter set (“PPS”) syntax structures indicating the values of syntax elements set by the host encoder for picture-layer syntax. The host encoder may also set values of syntax elements of the output bitstream for slice-header-layer syntax. For example, when the host encoder sets values of syntax elements of the output bitstream for slice-header-layer syntax, the output bitstream includes slice-header syntax structures indicating values of syntax elements set by the host encoder for slice-header-layer syntax (such as reference picture list information or reference picture set information). When it sets values of syntax elements for a given layer of syntax (e.g., sequence layer, picture layer or slice header layer), the host encoder can set the values of all of the syntax elements for that layer or only some of the syntax elements for that layer. The host encoder can also set values of syntax elements of the output bitstream for one or more supplemental enhancement information (“SEI”) messages, access unit delimiters (“AUDs”) to indicate picture boundaries, and/or other information. The host encoder can entropy code/format the values of syntax elements set by the host encoder, or it can pass the values to the accelerator for entropy coding/formatting. The host encoder can write the values of syntax elements set by the host encoder to the output bitstream, or it can pass the values to the accelerator for writing the output bitstream.

The host encoder also fills one or more control structures with values of control parameters. The control parameters can include one or more rate-control parameters that specify targets or factors that affect quality and/or bit rate. The host encoder can receive feedback information (e.g., complexity information, quality information and/or bit rate information for the media) from an accelerator (directly or indirectly) and determine values of the control parameters based at least in part on the feedback information. Other control structures can include information indicating results of pre-processing analysis (e.g., region of interest information, complexity information, noise type information, noise level information and/or luma sample level information), which may help the accelerator make some encoding decisions.

The host encoder initiates encoding of the media by an accelerator that includes accelerator hardware, passing the control structure(s) across an accelerator interface situated between the host encoder and the accelerator hardware. This facilitates control by the accelerator of encoding operations subject to the values of syntax elements set by the host encoder for the at least one of sequence-layer syntax and picture-layer syntax (and possibly slice-header-layer syntax). For example, the encoding operations controlled by the accelerator can include intra-picture estimation and prediction operations, motion estimation and compensation operations, frequency transform operations, quantization operations, and entropy coding/formatting operations (at least for lower-layer syntax for slice data such as macroblocks, sub-macroblocks, partitions, residual data units, coding tree units, coding units, prediction units, transform units, or parts thereof) for the media. The accelerator interface situated between the host encoder and the accelerator hardware can include an application programming interface (“API”) and device driver interface (“DDI”) between the host encoder and one or more device drivers. For example, the accelerator interface is operable to work with device drivers for any of multiple different types of accelerator hardware, and the accelerator interface is operable to work with host encoders for any of multiple codec standards or formats.

The accelerator performs encoding operations for lower syntax layers (e.g., macroblocks, sub-macroblocks, partitions, residual data units, coding tree units, coding units, prediction units, transform units, or parts thereof) of the media, subject to the parameters and values of syntax elements set by the host encoder. After encoding, the output bitstream includes syntax structures indicating values of syntax elements set by the accelerator for slice-data-layer syntax and lower layers of bitstream syntax for the media. Further, if the accelerator sets values of syntax elements of the output bitstream for slice-header-layer syntax, the output bitstream includes slice-header syntax structures indicating values of syntax elements set by the accelerator for slice-header-layer syntax.

Before encoding (or even during encoding for some encoding control properties), a host encoder can set values of encoding control properties in response to one or more calls by an application across an interface exposed by the host encoder. The interface exposed by the host encoder can include sub-routines (e.g., procedures, functions, member functions, interface methods, etc.) for setting the values of the encoding control properties and sub-routines for retrieving the values of the encoding control properties. The host encoder can also expose another interface that includes sub-routines for managing input streams and sub-routines for managing output streams.

The foregoing and other objects, features, and advantages of the invention will become more apparent from the following detailed description, which proceeds with reference to the accompanying figures.

### BRIEF DESCRIPTION OF THE DRAWINGS

FIG. 1 is a diagram of an example computing system in which some described embodiments can be implemented.

FIGS. 2a and 2b are diagrams of example network environments in which some described embodiments can be implemented.

FIG. 3 is a diagram of an example encoder system in conjunction with which some described embodiments can be implemented.

FIGS. 4a and 4b are diagrams illustrating an example video encoder in conjunction with which some described embodiments can be implemented.

FIGS. 5a and 5b are diagrams illustrating architectures for hardware-accelerated video encoding in which some described embodiments can be implemented.

FIG. 6 is a flowchart illustrating a generalized technique for hardware-accelerated video encoding with a host encoder.

### DETAILED DESCRIPTION

The detailed description presents innovations in the design and use of a host encoder for hardware-accelerated video encoding. In particular, by controlling decisions for high layers of bitstream syntax for encoded video, a host encoder provides consistent behaviors even when used with accelerator hardware from different vendors. For example, the host encoder can control high-level behaviors of encoding and set syntax elements for sequence layer and picture layer of an output bitstream (and possibly other layers such as slice-header layer), while using only a small amount of computational resources. An accelerator that includes accelerator hardware (and typically one or more device drivers for the accelerator hardware) then controls encoding decisions for lower layers of bitstream syntax (e.g., for intra-picture estimation and prediction, motion estimation and compensation, frequency transforms, quantization, and at least some entropy coding/formatting), in a manner consistent with the values of syntax elements set by the host encoder.

Although operations described herein are in places described as being performed by a video encoder, in many cases the operations can be performed by another type of media processing tool (e.g., image encoder or other data encoder).

Some of the innovations described herein are illustrated with reference to syntax elements and operations specific to the H.264/AVC standard or H.265/HEVC standard. The innovations described herein can also be implemented in hardware-accelerated encoding for other standards or formats. For example, innovations described herein can be used to provide hardware-accelerated encoding for VPx, SMPTE 421M or another current or future format.

In some examples described herein, hardware-accelerated encoding generally follows the approach of DirectX Video Acceleration (“DXVA”) for H.264/AVC, re-using call patterns, basic data flows, data structures, etc., or extending such call patterns, basic data flows, data structures, etc. Alternatively, innovations described herein are implemented for hardware-accelerated encoding according to another specification of the accelerator interface between host encoder and accelerator.

More generally, various alternatives to the examples described herein are possible. For example, certain techniques described with reference to flowchart diagrams can be altered by changing the ordering of stages shown in the flowcharts, by splitting, repeating or omitting certain stages, etc. The various aspects of the disclosed technology can be used in combination or separately. Different embodiments use one or more of the described innovations. Some of the innovations described herein address one or more of the problems noted in the background. Typically, a given technique/tool does not solve all such problems.

### I. EXAMPLE COMPUTING SYSTEMS

FIG. 1 illustrates a generalized example of a suitable computing system (100) in which several of the described innovations may be implemented. The computing system (100) is not intended to suggest any limitation as to scope of use or functionality, as the innovations may be implemented in diverse general-purpose or special-purpose computing systems.

With reference to FIG. 1, the computing system (100) includes one or more processing units (110, 115) and memory (120, 125). The processing units (110, 115) execute computer-executable instructions. A processing unit can be a general-purpose central processing unit (“CPU”), a processor in an application-specific integrated circuit (“ASIC”) or any other type of processor. In a multi-processing system, multiple processing units execute computer-executable instructions to increase processing power. For example, FIG. 1 shows a CPU (110) as well as a graphics processing unit or co-processing unit (115). The tangible memory (120, 125) may be volatile memory (e.g., registers, cache, RAM), non-volatile memory (e.g., ROM, EEPROM, flash memory, etc.), or some combination of the two, accessible by the processing unit(s). The memory (120, 125) stores software (180) implementing one or more innovations in design and use of a host encoder for hardware-accelerated video encoding, in the form of computer-executable instructions.

A computing system may have additional features. For example, the computing system (100) includes storage (140), one or more input devices (150), one or more output devices (160), and one or more communication connections (170). An interconnection mechanism (not shown) such as a bus, controller, or network interconnects the components of the computing system (100). Typically, operating system software (not shown) provides an operating environment for other software executing in the computing system (100), and coordinates activities of the components of the computing system (100).

The tangible storage (140) may be removable or non-removable, and includes magnetic disks, magnetic tapes or cassettes, CD-ROMs, DVDs, or any other medium which can be used to store information and which can be accessed within the computing system (100). The storage (140) stores instructions for the software (180) implementing one or more innovations in design and use of a host encoder for hardware-accelerated video encoding.

The input device(s) (150) may be a touch input device such as a keyboard, mouse, pen, or trackball, a voice input device, a scanning device, or another device that provides input to the computing system (100). For video, the input device(s) (150) may be a camera, video card, TV tuner card, or similar device that accepts video input in analog or digital form, or a CD-ROM or CD-RW that reads video input into the computing system (100). The output device(s) (160) may be a display, printer, speaker, CD-writer, or another device that provides output from the computing system (100).

The communication connection(s) (170) enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-readable media. Computer-readable media are any available tangible media that can be accessed within a computing environment. By way of example, and not limitation, with the computing system (100), computer-readable media include memory (120, 125), storage (140), and combinations of any of the above.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine,” “set” and “fill” to describe computer operations in a computing system. These terms are high-level abstractions for operations performed by a computer, and should not be confused with acts performed by a human being. The actual computer operations corresponding to these terms vary depending on implementation.

### II. EXAMPLE NETWORK ENVIRONMENTS

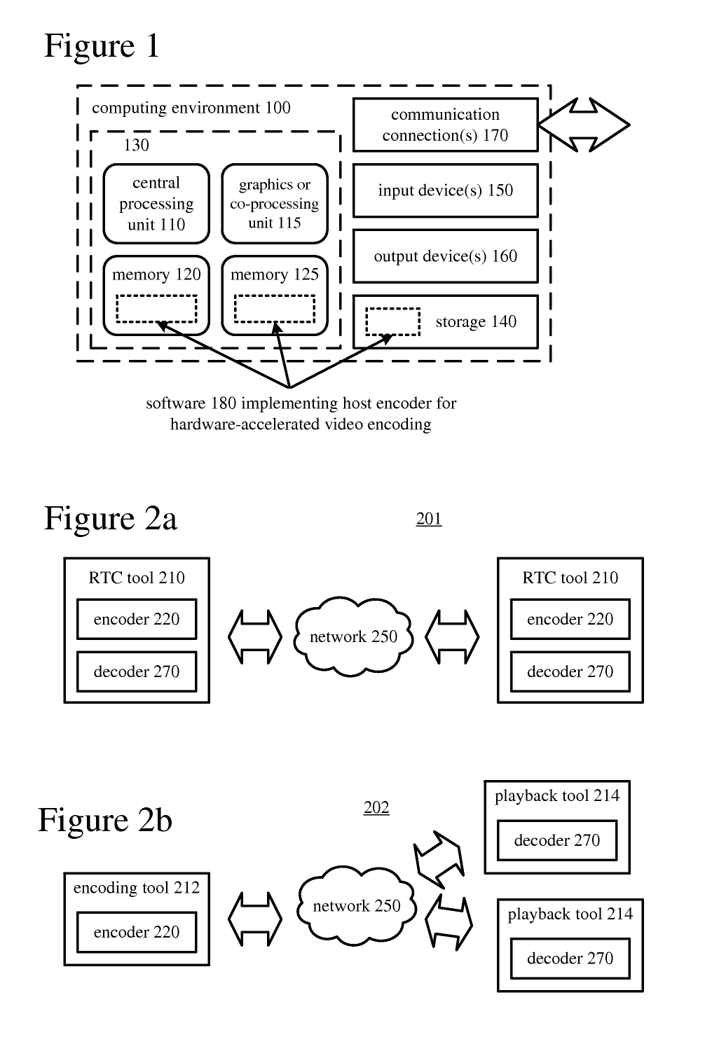

FIGS. 2a and 2b show example network environments (201, 202) that include video encoders (220) and video decoders (270). The encoders (220) and decoders (270) are connected over a network (250) using an appropriate communication protocol. The network (250) can include the Internet or another computer network.

In the network environment (201) shown in FIG. 2a, each real-time communication (“RTC”) tool (210) includes both an encoder (220) and a decoder (270) for bidirectional communication. A given encoder (220) can produce output compliant with the H.265/HEVC standard, SMPTE 421M standard, H.264/AVC standard, another standard, or a proprietary format, with a corresponding decoder (270) accepting encoded data from the encoder (220). The bidirectional communication can be part of a video conference, video telephone call, or other two-party or multi-party communication scenario. Although the network environment (201) in FIG. 2a includes two real-time communication tools (210), the network environment (201) can instead include three or more real-time communication tools (210) that participate in multi-party communication.

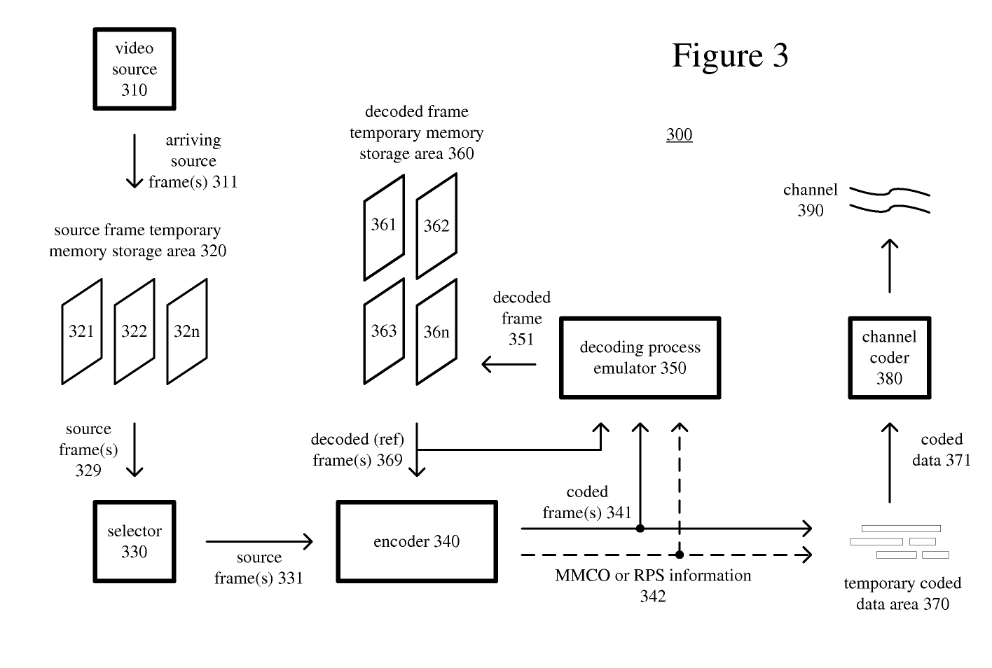

A real-time communication tool (210) manages encoding by an encoder (220). FIG. 3 shows an example encoder system (300) that can be included in the real-time communication tool (210). Alternatively, the real-time communication tool (210) uses another encoder system. A real-time communication tool (210) also manages decoding by a decoder (270).

In the network environment (202) shown in FIG. 2b, an encoding tool (212) includes an encoder (220) that encodes video for delivery to multiple playback tools (214), which include decoders (270). The unidirectional communication can be provided for a video surveillance system, web camera monitoring system, remote desktop conferencing presentation or other scenario in which video is encoded and sent from one location to one or more other locations. Although the network environment (202) in FIG. 2b includes two playback tools (214), the network environment (202) can include more or fewer playback tools (214). In general, a playback tool (214) communicates with the encoding tool (212) to determine a stream of video for the playback tool (214) to receive. The playback tool (214) receives the stream, buffers the received encoded data for an appropriate period, and begins decoding and playback.

FIG. 3 shows an example encoder system (300) that can be included in the encoding tool (212). Alternatively, the encoding tool (212) uses another encoder system. The encoding tool (212) can also include server-side controller logic for managing connections with one or more playback tools (214). A playback tool (214) can also include client-side controller logic for managing connections with the encoding tool (212).

### III. EXAMPLE ENCODER SYSTEMS

FIG. 3 is a block diagram of an example encoder system (300) in conjunction with which some described embodiments may be implemented. The encoder system (300) can be a general-purpose encoding tool capable of operating in any of multiple encoding modes such as a low-latency encoding mode for real-time communication, a transcoding mode, and a higher-latency encoding mode for producing media for playback from a file or stream, or it can be a special-purpose encoding tool adapted for one such encoding mode. The encoder system (300) can be adapted for encoding of a particular type of content (e.g., screen capture content). The encoder system (300) is implemented using a host encoder for some functionality and using an accelerator for other functionality, where the accelerator includes accelerator hardware and one or more device drivers for the accelerator hardware. Overall, the encoder system (300) receives a sequence of source video frames (311) from a video source (310) and produces encoded data as output to a channel (390).

The video source (310) can be a camera, tuner card, storage media, or other digital video source. The video source (310) produces a sequence of video frames at a frame rate of, for example, 30 frames per second. As used herein, the term “frame” generally refers to source, coded or reconstructed image data. For progressive-scan video, a frame is a progressive-scan video frame. For interlaced video, in example embodiments, an interlaced video frame might be de-interlaced prior to encoding. Alternatively, two complementary interlaced video fields are encoded together as a single video frame or encoded as two separately-encoded fields. Aside from indicating a progressive-scan video frame or interlaced-scan video frame, the term “frame” or “picture” can indicate a single non-paired video field, a complementary pair of video fields, a video object plane that represents a video object at a given time, or a region of interest in a larger image. The video object plane or region can be part of a larger image that includes multiple objects or regions of a scene.

An arriving source frame (311) is stored in a source frame temporary memory storage area (320) that includes multiple frame buffer storage areas (321, 322, . . . , 32n). A frame buffer (321, 322, etc.) holds one source frame in the source frame storage area (320). After one or more of the source frames (311) have been stored in frame buffers (321, 322, etc.), a frame selector (330), which may be directed by a host encoder, selects an individual source frame from the source frame storage area (320). The order in which frames are selected by the frame selector (330) for input to the encoder (340) may differ from the order in which the frames are produced by the video source (310), e.g., the encoding of some frames may be delayed in order, so as to allow some later frames to be encoded first and to thus facilitate temporally backward prediction. Before the encoder (340), the encoder system (300) can include a pre-processor (not shown) that performs pre-processing (e.g., filtering) of the selected frame (331) before encoding. Pre-processing functionality can be provided by the host encoder, or the host encoder can use the accelerator for at least some of the pre-processing operations. The pre-processing can include color space conversion into primary (e.g., luma) and secondary (e.g., chroma differences toward red and toward blue) components and resampling processing (e.g., to reduce the spatial resolution of chroma components) for encoding. Typically, before encoding, video has been converted to a color space such as YUV, in which sample values of a luma (Y) component represent brightness or intensity values, and sample values of chroma (U, V) components represent color-difference values. The precise definitions of the color-difference values (and conversion operations to/from YUV color space to another color space such as RGB) depend on implementation. In general, as used herein, the term YUV indicates any color space with a luma (or luminance) component and one or more chroma (or chrominance) components, including Y′UV, YIQ, Y′IQ and YDbDr as well as variations such as YCbCr and YCoCg. The chroma sample values may be sub-sampled to a lower chroma sampling rate (e.g., for YUV 4:2:0 format or YUV 4:2:2), or the chroma sample values may have the same resolution as the luma sample values (e.g., for YUV 4:4:4 format). In YUV 4:2:0 format, chroma components are downsampled by a factor of two horizontally and by a factor of two vertically. In YUV 4:2:2 format, chroma components are downsampled by a factor of two horizontally. Or, the video can be encoded in another format (e.g., RGB 4:4:4 format).

The encoder (340), with some operations performed by the host encoder and other operations performed by accelerator, encodes the selected frame (331) to produce a coded frame (341) and also produces memory management control operation (“MMCO”) signals (342) or reference picture set (“RPS”) information. The RPS is the set of frames that may be used for reference in motion compensation for a current frame or any subsequent frame. If the current frame is not the first frame that has been encoded, when performing its encoding process, the encoder (340) may use one or more previously encoded/decoded frames (369) that have been stored in a decoded frame temporary memory storage area (360). Such stored decoded frames (369) are used as reference frames for inter-frame prediction of the content of the current source frame (331). The MMCO/RPS information (342) indicates to a decoder which reconstructed frames may be used as reference frames, and hence should be stored in a frame storage area.

Generally, the encoder (340) includes multiple encoding modules that perform encoding tasks such as partitioning, intra-picture estimation and prediction, motion estimation and compensation, frequency transforms, quantization and entropy coding. The exact operations performed by the encoder (340) can vary depending on compression format. The format of the output encoded data can be H.265/HEVC format, H.264/AVC format, another H.26x format, a Windows Media Video format, VC-x format, an MPEG-x format, a VPx format, or another format. The host encoder performs at least some high-level encoding operations of the encoder (340), but other operations (e.g., intra-picture estimation and prediction, motion estimation and compensation, frequency transforms, quantization, and entropy coding/formatting for lower-layer syntax) are performed by the accelerator.

In H.265/HEVC implementations, the encoder (340) can partition a frame into multiple tiles of the same size or different sizes. For example, the encoder (340) splits the frame along tile rows and tile columns that, with frame boundaries, define horizontal and vertical boundaries of tiles within the frame, where each tile is a rectangular region. Tiles are often used to provide options for parallel processing. In H.265/HEVC implementations, H.264/AVC implementations and other implementations, a frame can be organized as one or more slices, where a slice can be an entire frame or region of the frame. A slice can be decoded independently of other slices in a frame, which improves error resilience. The content of a slice or tile is further partitioned into blocks or other sets of samples for purposes of encoding and decoding.

For syntax according to the H.264/AVC standard, the encoder (340) can partition a frame into multiple slices of the same size or different sizes. The encoder (340) splits the content of a frame (or slice) into 16×16 macroblocks. A macroblock includes luma sample values organized as four 8×8 luma blocks and corresponding chroma sample values organized as 8×8 chroma blocks. Generally, a macroblock has a prediction mode such as inter or intra. A macroblock includes one or more prediction units (e.g., 8×8 blocks, 4×4 blocks, which may be called partitions for inter-frame prediction) for purposes of signaling of prediction information (such as prediction mode details, motion vector (“MV”) information, etc.) and/or prediction processing. A macroblock also has one or more residual data units for purposes of residual coding/decoding.

For syntax according to the H.265/HEVC standard, the encoder (340) splits the content of a frame (or slice or tile) into coding tree units. A coding tree unit (“CTU”) includes luma sample values organized as a luma coding tree block (“CTB”) and corresponding chroma sample values organized as two chroma CTBs. The size of a CTU (and its CTBs) is selected by the encoder (340), and can be, for example, 64×64, 32×32 or 16×16 sample values. A CTU includes one or more coding units. A coding unit (“CU”) has a luma coding block (“CB”) and two corresponding chroma CBs. Generally, a CU has a prediction mode such as inter or intra. A CU includes one or more prediction units for purposes of signaling of prediction information (such as prediction mode details, displacement values, etc.) and/or prediction processing. A prediction unit (“PU”) has a luma prediction block (“PB”) and two chroma PBs. A CU also has one or more transform units for purposes of residual coding/decoding, where a transform unit (“TU”) has a transform block (“TB”) and two chroma TBs. The encoder (340) decides how to partition video into CTUs, CUs, PUs, TUs, etc.

In H.265/HEVC implementations, a slice can include a single slice segment (independent slice segment) or be divided into multiple slice segments (independent slice segment and one or more dependent slice segments). A slice segment is an integer number of CTUs ordered consecutively in a tile scan, contained in a single network abstraction layer (“NAL”) unit. For an independent slice segment, a slice segment header includes values of syntax elements that apply for the independent slice segment. For a dependent slice segment, a truncated slice segment header includes a few values of syntax elements that apply for that dependent slice segment, and the values of the other syntax elements for the dependent slice segment are inferred from the values for the preceding independent slice segment in decoding order.

As used herein, the term “block” can indicate a macroblock, prediction unit, residual data unit, or a CB, PB or TB, or some other set of sample values, depending on context.

Returning to FIG. 3, the encoder (340) represents an intra-coded block of a source frame (331) in terms of prediction from other, previously reconstructed sample values in the frame (331). For intra spatial prediction for a block, for example, an intra-picture estimator estimates extrapolation of the neighboring reconstructed sample values into the block. The intra-picture estimator can output prediction information (such as prediction mode (direction) for intra spatial prediction), which is entropy coded. An intra-frame prediction predictor applies the prediction information to determine intra-frame prediction values.

The encoder (340) represents an inter-frame coded, predicted block of a source frame (331) in terms of prediction from reference frames. A motion estimator estimates the motion of the block with respect to one or more reference frames (369). When multiple reference frames are used, the multiple reference frames can be from different temporal directions or the same temporal direction. A motion-compensated prediction reference region is a region of samples in the reference frame(s) that are used to generate motion-compensated prediction values for a block of samples of a current frame. The motion estimator outputs motion information such as MV information, which is entropy coded. A motion compensator applies MVs to reference frames (369) to determine motion-compensated prediction values for inter-frame prediction.

The encoder can determine the differences (if any) between a block's prediction values (intra or inter) and corresponding original values. These differences, or prediction residual values, are further encoded using a frequency transform, quantization and entropy encoding. For example, the encoder (340) sets values for quantization parameter (“QP”) for a picture, tile, slice and/or other portion of video, and quantizes transform coefficients accordingly. The entropy coder of the encoder (340) compresses quantized transform coefficient values as well as certain side information (e.g., MV information, QP values, mode decisions, parameter choices). Typical entropy coding techniques include Exponential-Golomb coding, Golomb-Rice coding, arithmetic coding, differential coding, Huffman coding, run length coding, variable-length-to-variable-length (“V2V”) coding, variable-length-to-fixed-length (“V2F”) coding, Lempel-Ziv (“LZ”) coding, dictionary coding, probability interval partitioning entropy coding (“PIPE”), and combinations of the above. The entropy coder can use different coding techniques for different kinds of information, can apply multiple techniques in combination (e.g., by applying Golomb-Rice coding followed by arithmetic coding), and can choose from among multiple code tables within a particular coding technique.

An adaptive deblocking filter is included within the motion compensation loop in the encoder (340) to smooth discontinuities across block boundary rows and/or columns in a decoded frame. Other filtering (such as de-ringing filtering, adaptive loop filtering (“ALF”), or sample-adaptive offset (“SAO”) filtering; not shown) can alternatively or additionally be applied as in-loop filtering operations.

The encoded data produced by the encoder (340) includes syntax elements for various layers of bitstream syntax. For syntax according to the H.264/AVC or H.265/HEVC standard, for example, a picture parameter set (“PPS”) is a syntax structure that contains syntax elements that may be associated with a picture. A PPS can be used for a single picture, or a PPS can be reused for multiple pictures in a sequence. A PPS is typically signaled separate from encoded data for a picture (e.g., one NAL unit for a PPS, and one or more other NAL units for encoded data for a picture). Within the encoded data for a picture, a syntax element indicates which PPS to use for the picture. Similarly, for syntax according to the H.264/AVC or H.265/HEVC standard, a sequence parameter set (“SPS”) is a syntax structure that contains syntax elements that may be associated with a sequence of pictures. A bitstream can include a single SPS or multiple SPSs. A SPS is typically signaled separate from other data for the sequence, and a syntax element in the other data indicates which SPS to use.

In some example implementations, a host encoder for the encoder (340) controls the high-level behaviors of encoding and sets at least some values of syntax elements for at least sequence layer and picture layer of syntax. For H.264/AVC implementations, the host encoder can also set values of syntax elements for slice headers. For example, for a slice to be encoded, the host encoder controls construction of reference picture lists for the slice. In general, a reference picture list (“RPL”) is an indexed list reference pictures that is constructed for the slice. The RPL includes reference pictures that can be used in motion compensation for the slice. The reference pictures in an RPL are selected from the RPS, but the RPS may include other pictures not in the RPL, and the RPL can include a given reference picture multiple times. The host encoder can also control coding format, information concerning output and display order relative to input and encoding order (e.g., picture order count), picture/slice type (I, P or B), whether the current picture is a reference picture, bit rate (e.g., through QP values, or through slice or picture size values, or by specifying bit rate for a sequence), entropy coding mode, deblocking filter decisions, and other encoding behaviors defined through the setting of syntax elements from SPS and PPS syntax structures up to slice headers. For H.265/HEVC implementations, the host encoder can similarly set values of syntax elements for SPSs, PPSs and slice headers (here, slice segment headers). The accelerator for the encoder (340) controls remaining encoding decisions. For H.264/AVC implementations, for example, the accelerator controls encoding decisions for slice data (macroblocks, sub-macroblocks, partitions, residual data units, or parts thereof), including decisions for motion estimation/compensation, intra-picture estimation/prediction and residual coding. Similarly, for H.265/HEVC implementations, the accelerator controls encoding decisions for blocks (CTBs of CTUs, CBs of CUs, PBs of PUs, TBs of TUs, etc.) within tiles and/or slices.

In some example implementations, the host encoder for the encoder (340) can make rate-control decisions, which are conveyed to the accelerator for the encoder (340). The accelerator can, in turn, perform rate-distortion optimization or other decision-making processes consistent with the rate-control targets specified by the host encoder. The accelerator may provide feedback information (e.g., about quality and/or bit rate of results of encoding) back to the host encoder, for the host encoder to use in rate-control decisions.

The coded frames (341) and MMCO/RPS information (342) (or information equivalent to the MMCO/RPS information (342), since the dependencies and ordering structures for frames are already known at the encoder (340)) are processed by a decoding process emulator (350). The decoding process emulator (350) implements some of the functionality of a decoder, for example, decoding tasks to reconstruct reference frames. In a manner consistent with the MMCO/RPS information (342), the decoding process emulator (350) determines whether a given coded frame (341) needs to be reconstructed and stored for use as a reference frame in inter-frame prediction of subsequent frames to be encoded. If a coded frame (341) needs to be stored, the decoding process emulator (350) models the decoding process that would be conducted by a decoder that receives the coded frame (341) and produces a corresponding decoded frame (351). In doing so, when the encoder (340) has used decoded frame(s) (369) that have been stored in the decoded frame storage area (360), the decoding process emulator (350) also uses the decoded frame(s) (369) from the storage area (360) as part of the decoding process. The host encoder can direct or perform at least some high-level operations of the decoding process emulator (350), with other operations performed by accelerator.

The decoded frame temporary memory storage area (360) includes multiple frame buffer storage areas (361, 362, . . . , 36n). In a manner consistent with the MMCO/RPS information (342), the decoding process emulator (350) (e.g., through the host encoder) manages the contents of the storage area (360) in order to identify any frame buffers (361, 362, etc.) with frames that are no longer needed by the encoder (340) for use as reference frames. After modeling the decoding process, the decoding process emulator (350) stores a newly decoded frame (351) in a frame buffer (361, 362, etc.) that has been identified in this manner.

The coded frames (341) and MMCO/RPS information (342) are buffered in a temporary coded data area (370). The coded data that is aggregated in the coded data area (370) contains, as part of the syntax of an elementary coded video bitstream, encoded data for one or more pictures. The coded data that is aggregated in the coded data area (370) can also include media metadata relating to the coded video data (e.g., as one or more parameters in one or more supplemental enhancement information (“SEI”) messages or video usability information (“VUI”) messages), which may be set by the host encoder.

The aggregated data (371) from the temporary coded data area (370) are processed by a channel encoder (380). The channel encoder (380) can packetize and/or multiplex the aggregated data for transmission or storage as a media stream (e.g., according to a media program stream or transport stream format such as ITU-T H.222.0 | ISO/IEC 13818-1 or an Internet real-time transport protocol format such as IETF RFC 3550), in which case the channel encoder (380) can add syntax elements as part of the syntax of the media transmission stream. Or, the channel encoder (380) can organize the aggregated data for storage as a file (e.g., according to a media container format such as ISO/IEC 14496-12), in which case the channel encoder (380) can add syntax elements as part of the syntax of the media storage file. Or, more generally, the channel encoder (380) can implement one or more media system multiplexing protocols or transport protocols, in which case the channel encoder (380) can add syntax elements as part of the syntax of the protocol(s). The channel encoder (380) provides output to a channel (390), which represents storage, a communications connection, or another channel for the output. The channel encoder (380) or channel (390) may also include other elements (not shown), e.g., for forward-error correction (“FEC”) encoding and analog signal modulation.

### IV. EXAMPLE VIDEO ENCODERS

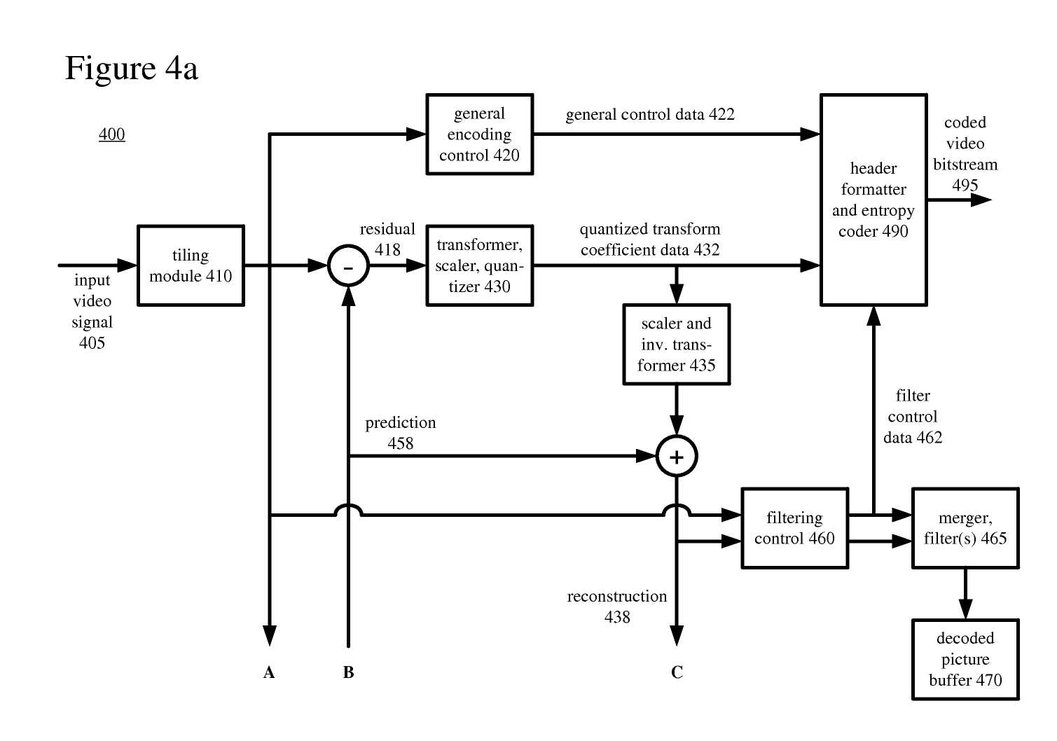

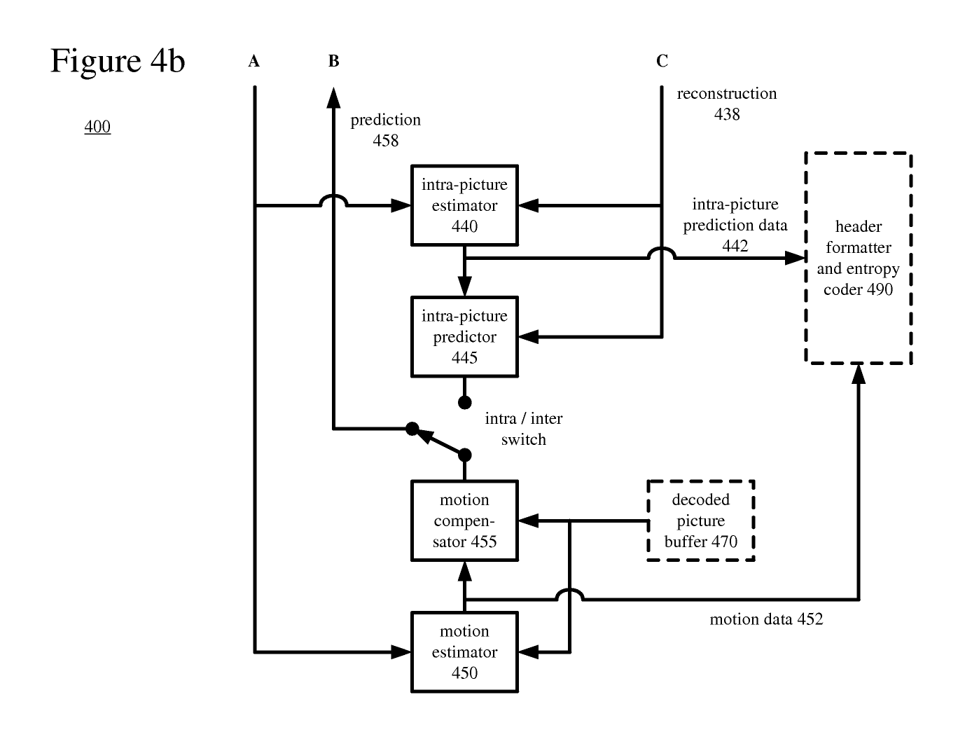

FIGS. 4a and 4b are a block diagram of a generalized video encoder (400) in conjunction with which some described embodiments may be implemented. The encoder (400) receives a sequence of video pictures including a current picture as an input video signal (405) and produces encoded data in a coded video bitstream (495) as output. The encoder (400) is implemented using a host encoder for some functionality and using an accelerator for other functionality, where the accelerator includes accelerator hardware and one or more device drivers for the accelerator hardware. In particular, the host encoder performs at least some high-level encoding operations of the encoder (400), but other operations are performed by the accelerator.

The encoder (400) is block-based and uses a block format that depends on implementation. Blocks may be further sub-divided at different stages, e.g., at the prediction, frequency transform and/or entropy encoding stages. In implementations of encoding for the H.264/AVC standard, for example, the encoder partitions a picture into slices that include macroblocks. As another example, in H.265/HEVC implementations, a picture can be divided into 64×64 blocks, 32×32 blocks or 16×16 blocks, which can in turn be divided into smaller blocks of sample values for coding and decoding—the encoder partitions a picture into CTUs (CTBs), CUs (CBs), PUs (PBs) and TU (TBs).

The encoder (400) compresses pictures using intra-picture coding and/or inter-picture coding. Many of the components of the encoder (400) are used for both intra-picture coding and inter-picture coding. The exact operations performed by those components can vary depending on the type of information being compressed.

In example implementations, a host encoder for the encoder (400) controls the high-level behaviors of encoding. The host encoder sets at least some values of syntax elements for sequence parameter set (“SPS”) and picture parameter set (“PPS”) syntax structures. For H.264/AVC implementations, the host encoder can also set at least some values of syntax elements for slice-header syntax structures. For example, for a slice to be encoded, the host encoder controls RPL construction for the slice, coding format, picture order count, picture/slice type (I, P or B), whether the current picture is a reference picture, bit rate (e.g., through QP values, or through slice or picture size values, or by specifying bit rate for a sequence), entropy coding mode, deblocking filter decisions, and other encoding behaviors. For H.265/HEVC implementations, the host encoder can similarly set at least some values of syntax elements for SPSs, PPSs and slice headers (here, slice segment headers). The accelerator for the encoder (400) controls remaining encoding decisions. For H.264/AVC implementations, for example, the accelerator controls encoding decisions for slice data (macroblocks, sub-macroblocks, partitions, residual data units, or parts thereof), including mode decisions for motion estimation/compensation, intra-picture estimation/prediction and residual coding. Similarly, for H.265/HEVC implementations, the accelerator controls encoding decisions for blocks (CTBs of CTUs, CBs of CUs, PBs of PUs, TBs of TUs, etc.) of tiles and/or slices.

In H.265/HEVC implementations, a tiling module (410) optionally partitions a picture into multiple tiles of the same size or different sizes. For example, the tiling module (410) splits the picture along tile rows and tile columns that, with picture boundaries, define horizontal and vertical boundaries of tiles within the picture, where each tile is a rectangular region. In H.264/AVC implementations or H.265/HEVC implementations, the encoder (400) partitions a picture into one or more slices, where each slice includes one or more slice segments.

The general encoding control (420), which is split between the host encoder (for high-level encoding decisions) and accelerator (for low-level encoding decisions), receives pictures for the input video signal (405) as well as feedback (not shown) from various modules of the encoder (400). Overall, the general encoding control (420) provides control signals (not shown) to other modules to set and change coding parameters during encoding. In particular, in some example implementations, the host encoder for the encoder (400) can make rate-control decisions, which are conveyed to the accelerator for the encoder (400). The accelerator can, in turn, perform rate-distortion optimization or other decision-making processes consistent with the rate-control targets specified by the host encoder. In the accelerator, the general encoding control (420) can also evaluate intermediate results about data or states during encoding, for example, to improve motion estimation or rate-distortion analysis. The general encoding control (420) produces general control data (422) that indicates decisions made during encoding, so that a corresponding decoder can make consistent decisions. The general control data (422) is provided to the header formatter/entropy coder (490).

If the current picture is predicted using inter-picture prediction, a motion estimator (450), which may be implemented by the accelerator, estimates the motion of blocks of sample values of the current picture of the input video signal (405) with respect to one or more reference pictures. The decoded picture buffer (“DPB”) (470) buffers one or more reconstructed previously coded pictures for use as reference pictures. In general, the host encoder controls the content of the DPB (470), but does not actually access the pictures in the DPB (470); the pictures in the DPB (470) are accessible to the accelerator. When multiple reference pictures are used, the multiple reference pictures can be from different temporal directions or the same temporal direction. The motion estimator (450) produces as side information motion data (452) such as MV data, merge mode index values (for H.265/HEVC implementations) and reference picture selection data. The motion data (452) is provided to the header formatter/entropy coder (490) as well as the motion compensator (455).

The motion compensator (455), which may be implemented by the accelerator, applies MVs to the reconstructed reference picture(s) from the DPB (470). The motion compensator (455) produces motion-compensated predictions for the current picture.

In a separate path within the encoder (400), an intra-picture estimator (440), which may be implemented by the accelerator, determines how to perform intra-picture prediction for blocks of sample values of a current picture of the input video signal (405). The current picture can be entirely or partially coded using intra-picture coding. Using values of a reconstruction (438) of the current picture, for intra spatial prediction, the intra-picture estimator (440) determines how to spatially predict sample values of a current block of the current picture from neighboring, previously reconstructed sample values of the current picture. The intra-picture estimator (440) produces as side information intra-picture prediction data (442), such as prediction mode direction (for intra spatial prediction). The intra-picture prediction data (442) is provided to the header formatter/entropy coder (490) as well as the intra-picture predictor (445).

According to the intra-picture prediction data (442), the intra-picture predictor (445), which may be implemented by the accelerator, spatially predicts sample values of a current block of the current picture from neighboring, previously reconstructed sample values of the current picture.

The intra/inter switch, which may be implemented by the accelerator, selects whether the prediction (458) for a given block will be a motion-compensated prediction or intra-picture prediction. The difference (if any) between a block of the prediction (458) and a corresponding part of the original current picture of the input video signal (405) provides values of the residual (418). During reconstruction of the current picture, reconstructed residual values are combined with the prediction (458) to produce an approximate or exact reconstruction (438) of the original content from the video signal (405). (In lossy compression, some information is lost from the video signal (405).)

In the transformer/scaler/quantizer (430), which may be implemented by the accelerator, a frequency transformer converts spatial-domain video data into frequency-domain (i.e., spectral, transform) data. For block-based video coding, the frequency transformer applies a discrete cosine transform, an integer approximation thereof, or another type of forward block transform to blocks of prediction residual data (or sample value data if the prediction (458) is null), producing blocks of frequency transform coefficients. The encoder (400) may also be able to indicate that such transform step is skipped. The scaler/quantizer scales and quantizes the transform coefficients. For example, the quantizer applies dead-zone scalar quantization to the frequency-domain data with a quantization step size that varies on a frame-by-frame basis, tile-by-tile basis, slice-by-slice basis, block-by-block basis, frequency-specific basis or other basis. The quantized transform coefficient data (432) is provided to the header formatter/entropy coder (490).

In the scaler/inverse transformer (435), which may be implemented by the accelerator, a scaler/inverse quantizer performs inverse scaling and inverse quantization on the quantized transform coefficients. An inverse frequency transformer performs an inverse frequency transform, producing blocks of reconstructed prediction residual values or sample values. Reconstructed residual values are combined with values of the prediction (458) (e.g., motion-compensated prediction values, intra-picture prediction values) to form the reconstruction (438).

For intra-picture prediction, the values of the reconstruction (438) can be fed back to the intra-picture estimator (440) and intra-picture predictor (445). Also, the values of the reconstruction (438) can be used for motion-compensated prediction of subsequent pictures. The values of the reconstruction (438) can be further filtered. A filtering control (460), which may be implemented by the accelerator, determines how to perform deblock filtering and SAO filtering on values of the reconstruction (438), for a given picture of the video signal (405). The filtering control (460) produces filter control data (462), which is provided to the header formatter/entropy coder (490) and merger/filter(s) (465).

In the merger/filter(s) (465), which may be implemented by the accelerator, the encoder (400) merges content from different tiles into a reconstructed version of the picture. The encoder (400) selectively performs deblock filtering and SAO filtering according to the filter control data (462), so as to adaptively smooth discontinuities across boundaries in the frames. Other filtering (such as de-ringing filtering or ALF; not shown) can alternatively or additionally be applied. Tile boundaries can be selectively filtered or not filtered at all, depending on settings of the encoder (400), and the encoder (400) may provide syntax elements within the coded bitstream to indicate whether or not such filtering was applied. The DPB (470) buffers the reconstructed current picture for use in subsequent motion-compensated prediction.

The header formatter/entropy coder (490), which may be implemented by the accelerator for lower-layer syntax elements and implemented by the host encoder for higher-layer syntax elements (or may be implemented by the accelerator for all syntax elements), formats and/or entropy codes the general control data (422), quantized transform coefficient data (432), intra-picture prediction data (442), motion data (452) and filter control data (462). For example, the host encoder controls formatting and entropy encoding for values of syntax elements in SPS and PPS syntax structures, SEI messages and AUDs, or elements thereof, while the accelerator controls formatting and entropy encoding for values of syntax elements in lower-layer syntax structures (macroblocks, sub-macroblocks, partitions, residual data units, CTUs (CTBs), CUs (CBs), PUs (PBs), TUs (TBs), etc.). Depending on implementation, the host encoder or accelerator may control formatting and entropy encoding for values of syntax elements in intermediate-layer syntax structures such as slice headers (for H.265/HEVC implementations, slice segment headers). The header formatter/entropy coder (490) provides the encoded data in the coded video bitstream (495). The format of the coded video bitstream (495) can be H.265/HEVC format, H.264/AVC format, another H.26x format, a Windows Media Video format, VC-x format, an MPEG-x format, a VPx format, or another format. Alternatively, the accelerator performs formatting and entropy coding of values of syntax elements set by the host encoder, which are passed to the accelerator.

Depending on implementation and the type of compression desired, modules of the encoder can be added, omitted, split into multiple modules, combined with other modules, and/or replaced with like modules. In alternative embodiments, encoders with different modules and/or other configurations of modules perform one or more of the described techniques. Specific embodiments of encoders typically use a variation or supplemented version of the encoder (400). The relationships shown between modules within the encoder (400) indicate general flows of information in the encoder; other relationships are not shown for the sake of simplicity.

### V. INNOVATIONS IN HARDWARE-ACCELERATED ENCODING

This section describes innovations in the design and use of a host encoder for hardware-accelerated encoding. In particular, the host encoder controls decisions for high layers of bitstream syntax for encoded video. For example, the host encoder can control high-level behaviors of encoding and set syntax elements for sequence layer and picture layer of an output bitstream (and possibly other layers such as slice-header layer). An accelerator that includes accelerator hardware (and possibly one or more device drivers for the accelerator hardware) then controls encoding decisions for lower layers of bitstream syntax, in a manner consistent with the values of syntax elements set by the host encoder. In this way, the host encoder can provide consistent behaviors even when used with accelerator hardware from different vendors across different hardware platforms, while using only a small amount of computational resources.

A. Background.

In modern video codec standards and formats, bitstreams of encoded video are hierarchically organized. Typically, parameters for a sequence are signaled as a sequence header or sequence parameter set (“SPS”) syntax structure. Parameters for a given picture of the sequence are signaled as a picture header or picture parameter set (“PPS”) syntax structure. Parameters for sections (e.g., tiles, slice, macroblocks, etc.) of a picture are signaled at successively lower layers of bitstream syntax for successively smaller sections of the picture.

In general, parameters for higher layers of syntax (such as SPSs, PPSs and slice headers in an H.264/AVC bitstream or H.265/HEVC bitstream, or sequence-layer, picture-layer and slice-header syntax elements more generally) consume a tiny fraction of the overall bit rate of encoded video. For example, by some estimates, SPSs, PPSs and slice headers consume about 0.01% of a typical high-quality H.264/AVC bitstream for high-definition video. (For lower-definition video, or video encoded at lower quality, the fraction may be much larger.) In most instances, values of syntax elements for sequence-layer, picture-layer and slice-header syntax are encoded using relatively simple encoding modes such as variations of Huffman coding, exponential Golomb coding or other variable-length coding, or fixed-length coding. Thus, the computational cost of encoding the values of syntax elements for sequence-layer, picture-layer and slice-header syntax is very low, even if the decision-making processes followed when setting those values are algorithmically complex. At the same time, the values of syntax elements for sequence-layer, picture-layer and slice-header syntax tend to be the most important values in the bitstream of encoded video, since they control almost all high-level behaviors during encoding (and corresponding decoding). For example, for H.264/AVC encoding and decoding, syntax elements in the SPS, PPS and slice headers control RPL construction, picture (slice) type, reference picture relationships among pictures, compressed picture size (through QP values), display format, coding format, output and display order relative to input and encoding order, tile and slice partitioning, entropy encoding mode, deblocking filter usage, minimum decoding latency, error resilience, and the number of temporal layers/temporal layer structuring, among other aspects of encoding and decoding.

In one previous architecture for hardware-accelerated video encoding, an independent hardware vendor (“IHV”) provides a host encoder that exposes two interfaces. A media foundation transform (“MFT”) interface (“IMFTransform”) includes sub-routines (e.g., procedures, functions, member functions, interface methods, etc.) for managing input streams and sub-routines for managing output streams. An ICodecAPI interface includes sub-routines for setting the values of various encoding control properties and sub-routines for retrieving the values of those encoding control properties. A host encoder is supposed to control encoding in a manner consistent with the specification for the ICodecAPI interface, but otherwise the control of high-level behaviors and the setting of values of syntax elements are left to the host encoder provided by the IHV. This gives IHVs freedom and flexibility in implementing host encoders. In practice, however, for the same ICodecAPI settings, host encoders from different IHVs can perform encoding that results in very different bitstreams of encoded video. In extreme cases, the host encoder provided by an IHV may encode video in a manner that is inconsistent with ICodecAPI settings.

For example, the ICodecAPI setting CODECAPI_AVEncVideoMaxNumRefFrame specifies the maximum number of reference frames supported by an encoder. This controls memory utilization (for reference pictures) and may, in some implementations, affect the complexity of motion estimation. For the H.264/AVC standard, the CODECAPI_AVEncVideoMaxNumRefFrame setting maps to the SPS syntax element max_num_ref_frames. Although most host encoders correctly set max_num_ref_frames from the CODECAPI_AVEncVideoMaxNumRefFrame setting in simple scenarios, the maximum number of reference frames is affected by whether long-term reference pictures are supported and whether temporal scalability up to three layers is supported. Host encoders from many IHVs do not honor the setting properly when a certain number of long-term reference pictures is enabled and/or when temporal scalability up to three layers is enabled.

As another example, in order to control the size of a group of pictures (“GOP”), the ICodecAPI setting CODECAPI_AVEncMPVGOPSize specifies the maximum number of frames (in frames) from the current key frame (intra-picture coded frame that starts the GOP) to the next key frame. (In this context, a GOP is a series of one or more pictures intended to assist random access. Typically, a GOP begins with an I-picture.) The size of a GOP is affected, however, by whether temporal scalability with some number of layers is enabled and/or whether B-picture encoding is enabled. For the same value of CODECAPI_AVEncMPVGOPSize, host encoders from different IHVs might behave very differently depending on whether temporal scalability and/or B-picture encoding are used.

As another example, in general, using long-term reference pictures (with careful selection of short-term reference pictures) facilitates recovery from network packet losses. In the H.264/AVC standard, selection and updating of short-term reference pictures can be signaled using MMCO information, RPL reordering syntax elements or sliding window DPB management. Among these options, some ways of using MMCO information are not robust to network packet losses. In these ways of using MMCO information, if MMCO information for a picture is lost, DPB state diverges between encoder and decoder and may remain out-of-sync for a while, which impedes error recovery. Nevertheless, some host encoders from IHVs use MMCO information in these ways that are not robust to loss.

In summary, when high-level behaviors vary in host encoders from different IHVs, compatibility and consistency may become an issue. When a given application applies encoder settings, host encoders running on computer systems with different accelerator hardware may create very different bitstreams of encoded video. Further, when incompatibility or inconsistent behaviors are identified between host encoders, correcting or mitigating the problems can be resource-intensive and expensive.

B. Controlling High-Level Behaviors of a Host Encoder.

According to innovations described herein, a host encoder controls decisions for high layers of bitstream syntax for encoded video. In some example implementations, for high-definition video encoded with high quality, the host encoder controls almost all high-level behaviors and syntax elements while using only a small amount of the computational resources available for encoding. In this way, the host encoder can provide consistent behaviors even when used with accelerator hardware from different vendors.

For example, the host encoder sets values of syntax elements (some or all) for sequence layer and picture layer of an output bitstream, as well as values of syntax elements (some or all) for slice-header layer. An accelerator (including accelerator hardware and one or more device drivers for the accelerator hardware) then controls encoding decisions for lower layers of bitstream syntax, in a manner consistent with the values of syntax elements set by the host encoder. For the H.264/AVC standard, the host encoder can set the values of syntax elements in the SPS and PPS syntax structures. When encoding a slice of a picture, the host encoder can also set the values of syntax elements of the slice header for the slice. Collectively, the syntax elements set by the host encoder control most high-level behaviors of encoding, including RPL construction for the slice, RPS updates, coding format, picture order count, picture (slice) type, whether the current picture is a reference picture, compressed picture size (through QP values), error resilience, the number of temporal layers/temporal layer structuring, slice size (in macroblocks), entropy encoding mode, deblocking filter usage, and other aspects of encoding.

In some example implementations, the host encoder encodes (formats, entropy codes, etc.) values of syntax elements in SPS syntax structures, PPS syntax structures, SEI messages, AUDs (to indicate picture boundaries) and slice-header syntax structures of an output H.264/AVC bitstream. For a given primary picture, the host encoder can write the SPS syntax structure (if any), PPS syntax structure (if any), SEI messages (if any), AUD (if any) and slice-header syntax structure(s), or elements thereof, to the output buffer(s) for the H.264/AVC-encoded video. The accelerator continues by encoding slice data (macroblocks, sub-macroblocks, partitions, residual data units, etc.) of the primary picture (e.g., performing operations for intra-picture estimation and prediction, motion estimation and compensation, frequency transforms, quantization, and entropy coding/formatting for lower-layer syntax), in a manner consistent with the values of the syntax elements in the SPS, PPS and slice headers. The accelerator encodes (formats, entropy codes, etc.) values of syntax elements in macroblock syntax structures, prediction unit syntax structures, residual data syntax structures, etc. of an output H.264/AVC bitstream. The accelerator can write syntax structures for the macroblocks, prediction units, residual data units, etc. to the output buffer(s) for the H.264/AVC-encoded video, to complete the NAL units for the slices and primary picture.

The accelerator controls encoding decisions for lower layers of bitstream syntax. For example, the accelerator controls prediction mode decisions, rate-distortion optimization or other decision-making processes, subject to the values of syntax elements set by the host encoder in the SPS syntax structure and PPS syntax structures and slice headers (for H.265/HEVC implementations, slice segment headers). For inter-picture prediction, the accelerator can control MV search and selection during motion estimation. For intra-picture prediction, the accelerator can control selection of prediction direction. Different IHVs can implement different algorithmic designs for the decision-making processes of the accelerator, which facilitates customization and innovation in the algorithmic designs.

In alternative approaches, the accelerator has more control over encoding. For example, the host encoder controls sequence-layer syntax and picture-layer syntax (such as values of (some or all) syntax elements of SPS syntax structures and PPS syntax structures), as well as SEI messages and AUDs, but the accelerator controls slice-header syntax and lower layers of bitstream syntax. For H.264/AVC encoding, for example, this allows an IHV to specify the decision-making processes that accelerator hardware follows when setting slice-layer QP values and slice type values, in addition to giving more control over decoded picture buffer (“DPB”) usage. For a given primary picture, the host encoder can write the SPS syntax structure (if any), PPS syntax structure (if any), SEI messages (if any), and AUD (if any), or elements thereof, to the output buffer(s) for the H.264/AVC-encoded video. The accelerator continues by making slice-header decisions and encoding slice data (macroblocks, sub-macroblocks, partitions, residual data units, etc.) of the primary picture (e.g., performing operations for intra-picture estimation and prediction, motion estimation and compensation, frequency transforms, quantization, and entropy coding/formatting for lower-layer syntax), in a manner consistent with the values of the syntax elements in the SPS and PPS syntax structures. The accelerator can write slice-header syntax structures and syntax structures for the macroblocks, prediction data units, residual data units, etc. to the output buffer(s) for the H.264/AVC-encoded video, to complete the NAL units for the slices and primary picture.

The host encoder can manage rate control for encoding. For example, the host encoder can perform rate control according to a quality-based approach, constant bit rate (“CBR”) approach, variable bit rate (“VBR”) approach, constrained VBR approach or unconstrained bit rate approach. For two-pass video encoding (in which the encoder evaluates video and encoding options in a first pass, then performs encoding in a second pass) or 1.5-pass video encoding (in which the encoder looks ahead for several frames to evaluate video and encoding options), the accelerator can provide feedback information to the host encoder, e.g., through the same accelerator interface used to convey other information to/from accelerator hardware or through a different interface. The feedback information can include complexity information, quality information and/or bit rate information for the video from the first pass of two-pass encoding or from the look-ahead frames for 1.5-pass video encoding. Or, the feedback information can simply be bit rate information for the last coded frame.

In addition to specifying control parameters (e.g., for rate control) and syntax elements of higher-layer syntax structures, the host encoder can provide the accelerator with information about characteristics of input pictures. Such information can be provided across an interface situated between the host encoder and accelerator hardware, which may be the same as the accelerator interface used to convey other information to/from accelerator hardware or may be a different interface. For example, to assist the accelerator in making its decisions, the host encoder can provide information about one or more of a region of interest (“ROI”) for a picture, complexity of different parts of a picture, noise type, noise level, picture sharpness, luma sample levels (for weighted prediction), hints about likely MVs, etc. ROI information can be provided to indicate where pictures include faces or other areas that may merit additional quality during encoding. ROI information can be parameterized, for example, as QP values for different areas of a picture.

In some example implementations, the host encoder can expose (to an application) an interface that includes sub-routines for setting the values of encoding control properties and sub-routines for retrieving the values of the encoding control properties. For example, the interface is the ICodecAPI interface or variation thereof. The host encoder can also expose another interface that includes sub-routines for managing input streams and sub-routines for managing output streams. For example, the other interface is the IMFTransform interface or variation thereof. Through one or more of these interfaces, or otherwise, an application can initialize the host encoder, setting input resolution, output resolution, target bit rate or quality, encoding profile, level of encoding, etc. The interface(s) or another interface can also support resetting of certain encoding control properties (e.g., resolution, bit rate) during encoding, without re-allocating all resources, so as to allow for dynamic changes to resolution or rate. Also, the interface(s) or another interface exposed by the host encoder can support querying for accelerator capabilities (e.g., maximum resolution supported, encoding profile(s) supported, encoding level(s) supported, maximum number of reference pictures supported, coding formats supported, color spaces supported, and so on) and/or pre-processing capabilities of the host encoder (e.g., noise analysis, face detection, luma sample level analysis).

In some example implementations, the accelerator can perform pre-processing analysis operations on pictures to be encoded. Even though high-level decisions may already have been made by the host encoder, the accelerator can perform scene change detection, complexity analysis, optical flow detection or other analysis to support intelligent decisions by the accelerator, subject to the values of syntax elements set by the host encoder.

C. Architectures for Hardware-Accelerated Video Encoding.

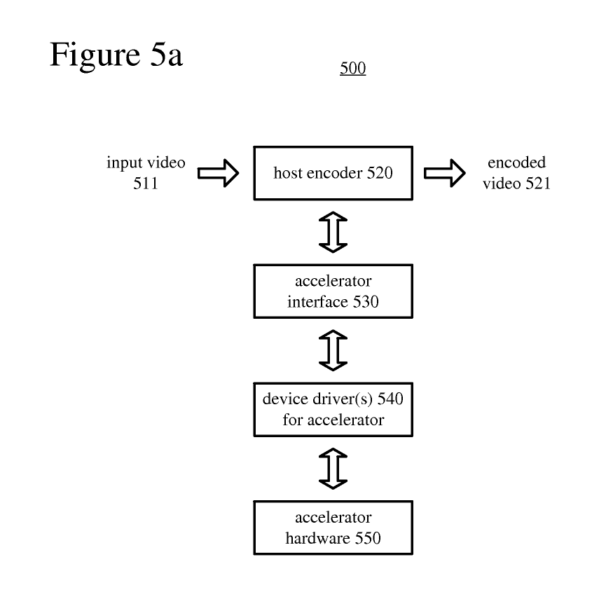

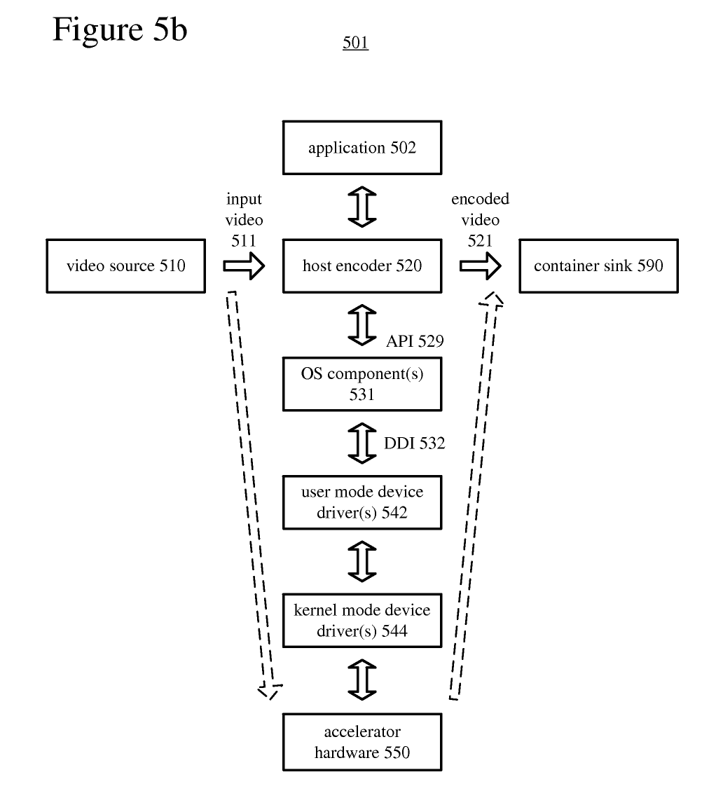

FIG. 5a shows a generalized architecture (500) for hardware-accelerated encoding. FIG. 5b shows a specific example architecture (501) for hardware-accelerated encoding.

The generalized architecture (500) includes a host encoder (520), an accelerator interface (530), one or more device drivers (540) for an accelerator and accelerator hardware (550) for the accelerator. The device driver(s) (540) and accelerator hardware (550) collectively provide functionality for the accelerator. The accelerator hardware (550) can be, for example, one or more GPUs or special-purpose encoding hardware.

The host encoder (520) manages input video (511) that is provided for encoding. The host encoder (520) can receive and process the input video (511), then pass the input video (511) to the accelerator, but that can involve significant transfers of data. Instead, the host encoder (520) typically manages access to the input video (511), which is buffered in picture buffers or other storage areas accessible to the accelerator. In this way, the input video (511) bypasses the host encoder (520), which passes the input video (511) by reference to the accelerator. As shown in FIG. 5b, a video source (510) can provide the input video (511). The video source (510) can be a camera, tuner card, storage media, or other digital video source, which produces a sequence of video frames for encoding. The input video (511), after optional pre-processing that includes color space conversion and/or chroma sub-sampling, can be in YUV 4:2:0 format, YUV 4:2:2 format, YUV 4:4:4 format or another format.

In the architecture (501) shown in FIG. 5b, an application (502) retrieves and sets the values of encoding control properties for the host encoder, and otherwise manages certain high-level aspects of encoding (e.g., providing encoding hints for a sequence or even individual pictures). The application (502) can be, for example, a transcoding application, streaming application, camera application, screen capture application, or other type of application. The application (502) can communicate with the host encoder (520) through one or more interfaces exposed by the host encoder (520) (e.g., ICodecAPI and/or IMFTransform interfaces, or variations thereof).

The host encoder (520) controls overall encoding and performs some encoding operations using a host CPU or CPUs. In addition to setting at least some values of higher-layer syntax elements in the encoded video (521), the host encoder (520) provides control information and other data to the device driver(s) (540) for the accelerator hardware (550) across an accelerator interface (530). Typically, the host encoder (520) is implemented as application software (as shown in FIG. 5b) or user-mode software.

To the host encoder (520), the accelerator interface (530) provides a consistent interface to the accelerator, regardless of the provider of the accelerator. Conversely, to an accelerator, the accelerator interface (530) provides a consistent interface to a host encoder, regardless of the provider of the host encoder. The details of the accelerator interface (530) depend on implementation. For example, as shown in FIG. 5b, the accelerator interface (530) can be exposed to the host encoder (520) as an API (529). When the host encoder (520) calls sub-routines of the API (529), one or more operating system (“OS”) components (531) check the validity of parameters, adjust pointers, or otherwise handle the calls. Similarly, the device driver(s) (540) associated with the accelerator can be exposed through a device driver interface (“DDI”) (532) of the accelerator interface (530), which includes sub-routines that the OS component(s) (531) call to pass control information and other data (by value or by reference) to the device driver(s) (540) associated with the accelerator. Alternatively, the accelerator interface (530) includes a single layer of software between the host encoder (520) and the device driver(s) (540) associated with the accelerator, or the accelerator interface (530) has some other organization.

In an example interaction, the host encoder (520) fills one or more buffers with instructions and data then calls a sub-routine (e.g., procedure, function, member function, interface method, etc.) of the accelerator interface (530) to alert the device driver(s) (540) through the OS. The buffered instructions and data, after optional parameter checking, formatting, adjustments, etc. by the OS, are passed (by value, by reference or by some other means) to the device driver(s) (540), and data is transferred (by value, by reference or by some other means) to memory of the accelerator hardware (550) if appropriate. After the accelerator hardware (550) finishes encoding, the device driver(s) (540) notify the host encoder (520) (e.g., by user event or callback) that encoded video for the output bitstream is available in output buffer(s). The host encoder (520) can receive and process the encoded video from the accelerator through the device driver(s) (540), but that can involve significant transfers of data. Instead, the encoded video buffered in the output buffer(s) is typically passed by reference to the host encoder (520).

While a particular implementation of the API (529) and DDI (532) may be tailored to a particular OS or platform, in some cases, the API (529) and/or DDI (532) can be implemented for multiple different OSs or platforms. Instructions, control structures, input video, encoded video, other data, etc. can be passed, transferred, sent, etc. across the API (529), DDI (332) or another interface between modules in the system by value or by reference, using any available mechanism to convey data from one entity (e.g., video source, host encoder, device driver layer or accelerator hardware) to another entity (e.g., host encoder, device driver layer, accelerator hardware or container sink).

In order to impose consistency in the format, organization and timing of data passed between the host encoder (520) and accelerator, an interface specification for the accelerator interface (530) can define a protocol for instructions and data for encoding according to a particular codec standard or format. The host encoder (520) follows specified conventions when writing to buffers or reading from buffers, locking or releasing buffers as appropriate to avoid interfering with operations of the device driver(s) (540), and notifying the device driver(s) (540) as needed about buffer status. The device driver(s) (540) retrieve buffered instructions and data according to the specified conventions, perform (with the accelerator hardware (550)) encoding, write to output buffers, and notify the host encoder (520) as needed about buffer status. For example, the accelerator interface (530) can include a sub-routine to begin encoding for a picture, sub-routines to allocate buffers, submit buffers for encoding, and release buffers, and a sub-routine to end encoding for a picture. After calling the sub-routine to begin encoding for a picture, the host encoder (520) as needed calls sub-routines to allocate input buffers, output buffers and buffers for control structures, and to add data to those buffers (e.g., adding SPS, PPS and slice-header syntax structures to the output buffer). The host encoder (520) then calls a sub-routine to initiate encoding operations according to the buffered instructions and data. When encoding has finished for the picture, the host encoder (520) calls the sub-routine to end encoding and can call sub-routines to release input buffers, output buffers or other buffers. Alternatively, the encoder can call the sub-routines to begin encoding, allocate buffers, convey data, initiate encoding, etc. on a slice-by-slice basis, tile-by-tile basis or some other basis.

In terms of the data structures used to convey instructions and data, an interface specification for a specific standard or format is adapted to the particular bitstream syntax and semantics of the standard/format. Data structures may be different for different codec standards or formats, even if the underlying call patterns through the accelerator interface (530) are the same. In some example implementations, the accelerator interface (530) is extensible—new capabilities can be added while backward compatibility is maintained.

Depending on implementation, memory for input buffer(s) for input video (511), output buffer(s) for encoded video (521) and buffers for control structure(s) can be allocated from system memory or from video memory. Different device drivers may use different types of memory.

In some implementations, the host encoder (520) manages memory usage during encoding. The host encoder (520) controls content of the DPB, controls creation, reuse and release of buffers, and controls reference picture utilization. The host encoder (520) also writes SPS syntax structures, PPS syntax structures, SEI messages, AUDs, slice headers (for H.265/HEVC implementations, slice segment headers), or elements thereof, and values of other syntax elements that are set by the host encoder (520) to an output buffer. The host encoder (520) can use various tracking structures (e.g., queues) to manage memory. In other implementations, the device driver(s) (540) manage at least some aspects of memory usage during encoding. For example, the device driver(s) (540) control creation, reuse and release of buffers. In this case, after the host encoder (520) sets the values of syntax elements for SPS syntax structures, PPS syntax structures, SEI messages, AUDs, slice headers (e.g., slice segment headers), etc., the host encoder (520) passes the values to the device driver(s) (540), which write them to the output buffer. In this case, the device driver(s) (540) can also entropy code/format the values of syntax elements set by the host encoder (520), before writing them to the output buffer.

In FIG. 5b, the device driver(s) (540) are split into one or more user-mode device drivers (542) and one or more kernel-mode device drivers (544). For example, the user-mode device driver(s) (542) can include a user-mode device driver provided by an IHV, which is called through the accelerator interface (530), and a user-mode device driver provided by an OS, which is called by the IHV-provided user-mode device driver. Similarly, the kernel-mode device driver(s) (544) can include a kernel-mode device driver provided by the OS (which communicates with the user-mode device driver provided by the OS) and a kernel-mode device driver provided by the IHV, which directly controls the accelerator hardware (550). Alternatively, for another OS architecture, the device driver(s) (540) include only one or more kernel-mode device drivers.

In general, the accelerator hardware (550) provides encoding operations for a codec standard or format, subject to the values of syntax elements set by the host encoder for higher-layer syntax. The division of encoding operations between the host encoder (520) and the accelerator depends on implementation, and it can vary for different acceleration profiles. In one acceleration profile, for example, the host encoder (520) controls overall encoding, manages DPB state, controls RPL construction, specifies how to perform reference picture marking and reordering, and otherwise manages RPS updates. The host encoder (520) selects and encodes values of syntax elements of SPS syntax structures, PPS syntax structures, slice headers (e.g., slice segment headers), SEI messages and AUDs, or elements thereof. The remaining encoding functions such as motion estimation and compensation, intra-picture estimation and prediction, frequency transforms, quantization and loop filtering are offloaded to the accelerator. Entropy coding/formatting can be split between the host encoder (520) and accelerator, depending on the syntax elements being encoded. Or, entropy coding/formatting can be performed by the accelerator for values of syntax elements set by the accelerator and for values of syntax elements set by the host encoder (520) then passed to the accelerator. Alternatively, for a different acceleration profile, the accelerator performs certain encoding tasks instead of the host encoder (520), or the host encoder (520) performs certain additional tasks otherwise performed by the accelerator.

As shown in FIG. 5b, a container sink (590) can perform additional formatting of the encoded video (521). For example, the container sink (590) can packetize and/or multiplex the encoded video (521) for transmission or storage as a media stream, organize the encoded video (521) for storage as a file, or otherwise implement one or more media system multiplexing protocols or transport protocols, as described with reference to FIG. 3.

D. Techniques for Hardware-Accelerated Encoding Using a Host Encoder.

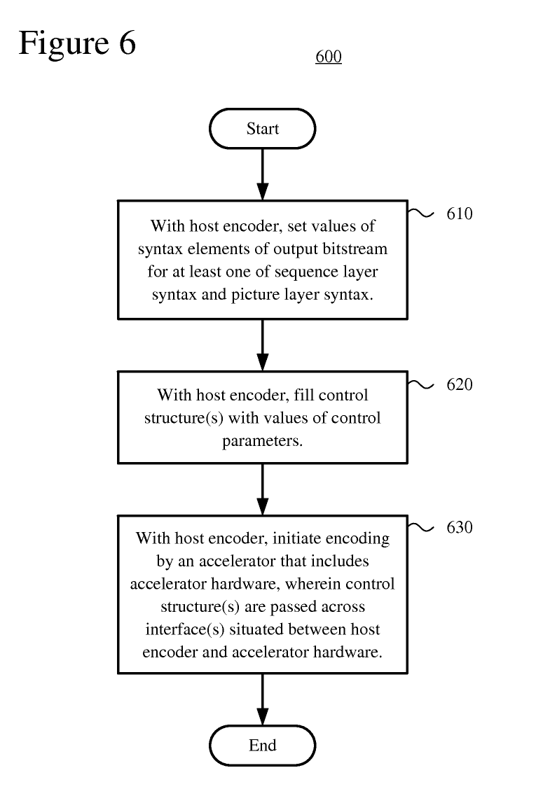

FIG. 6 shows a generalized technique (600) for hardware-accelerated encoding with a host encoder. A video encoder as described with reference to FIG. 3 or FIGS. 4a and 4b, or another media encoder, performs the technique (600). The encoder includes a host encoder and accelerator hardware for an accelerator. The encoder can also include one or more device drivers between the host encoder and accelerator hardware.

The host encoder sets (610) values of syntax elements of an output bitstream for at least one of sequence-layer syntax and picture-layer syntax for media (e.g., video). For example, an output bitstream for H.264/AVC or H.265/HEVC includes at least one SPS syntax structure indicating the values of syntax elements set by the host encoder for sequence-layer syntax and includes at least one PPS syntax structure indicating the values of syntax elements set by the host encoder for picture-layer syntax for video. SPS syntax structures are one possible organization for syntax elements for sequence-layer syntax. Alternatively, the syntax elements for sequence-layer syntax can be part of a sequence header that precedes encoded data for a sequence in a bitstream. PPS syntax structures are one possible organization of syntax elements for picture-layer syntax. Alternatively, the syntax elements for picture-layer syntax can be part of a picture header that precedes encoded data for a picture in the bitstream.

The host encoder may also set values of syntax elements of the output bitstream for slice-header-layer syntax. For example, when they are set by the host encoder, the output bitstream for H.264/AVC or H.265/HEVC can also include slice-header syntax structures (such as slice headers for H.264/AVC, or slice segment headers for H.265/HEVC) indicating values of syntax elements set by the host encoder for slice-header-layer syntax (e.g., syntax elements for RPL construction).

When the host encoder sets values of syntax elements for a given layer of syntax (e.g., sequence layer, picture layer or slice header layer), the host encoder can set the values of all of the syntax elements for that layer (e.g., an entire SPS, entire PPS, or entire slice header). Or, when the host encoder sets values of syntax elements for a given layer of syntax (e.g., sequence layer, picture layer or slice header layer), the host encoder can set the values of only some of the syntax elements for that layer (e.g., part of an SPS, part of a PPS, or part of a slice header), with the remaining elements for the given layer set by the accelerator. For the values of syntax elements set by the host encoder, the host encoder can also perform entropy coding/formatting and writing of the values to the output bitstream. Or, for the values of syntax elements set by the host encoder, the accelerator can perform entropy coding/formatting and/or writing of the values to the output bitstream. In any case, the values of syntax elements set by the host encoder are passed to the accelerator.

The host encoder can also set values of syntax elements of one or more SEI messages, AUDs and/or other information for the H.264/AVC or H.265/HEVC bitstream.

For a bitstream syntax that lacks sequence-layer syntax, the host encoder sets values of syntax elements for picture-layer syntax. Or, for a bitstream syntax that includes additional layers of syntax between sequence layer and picture layer (e.g., entry-point layer or GOP layer), the host encoder sets values of syntax elements for the additional layers in addition to sequence layer and picture layer.

Returning to FIG. 6, the host encoder also fills (620) one or more control structures with values of control parameters. For example, the control parameters include one or more rate-control parameters that specify targets or factors that affect quality and/or bit rate. The control structure(s) can further include information indicating results of pre-processing analysis by the host encoder or an application (e.g., region of interest information, complexity information, noise type information, noise level information and/or luma sample level information).

The host encoder initiates (630) encoding of the media by an accelerator that includes accelerator hardware. The host encoder passes the control structure(s) across an accelerator interface situated between the host encoder and the accelerator hardware. This facilitates control by the accelerator of encoding operations, subject to the values of syntax elements set by the host encoder for sequence-layer syntax and/or picture-layer syntax. The host encoder can also specify one or more input buffers for frames of the media and one or more output buffers for encoded data for the output bitstream (e.g., including syntax elements set by the host encoder). The accelerator interface situated between the host encoder and the accelerator hardware can include an API and/or DDI between the host encoder and device driver(s) for the accelerator. For example, the accelerator interface is operable to work with device drivers for any of multiple different types of accelerator hardware, and the accelerator interface is operable to work with host encoders for any of multiple codec standards or formats (e.g., H.26x, MPEG-x, VC-x, VPx).

The accelerator controls encoding operations for lower syntax layers (e.g., macroblocks, sub-macroblocks, partitions, residual data units, CTUs, CUs, PUs, TUs, etc.) of the media, subject to the parameters and values of syntax elements set by the host encoder. For example, the accelerator can control intra-picture estimation and prediction operations, motion estimation and compensation operations, frequency transform operations, quantization operations, and entropy coding/bitstream formatting operations for lower-layer syntax for the media. After the accelerator writes values of syntax elements to the output bitstream, the output bitstream includes syntax structures indicating values of syntax elements set by the accelerator for lower-layer syntax for the media. For example, for an H.264/AVC bitstream, the bitstream includes slice-data-layer syntax structures, prediction unit syntax structures, residual data unit syntax structures, etc. When they are set by the accelerator, the output bitstream can also include slice-header syntax structures indicating values of syntax elements set by the accelerator for slice-header-layer syntax.

For the sake of simplicity, FIG. 6 does not show the timing of encoding operations for a video sequence. In practice, for example, a host encoder may set the values of syntax elements for sequence-layer syntax, then, on a picture-by-picture basis, (1) set the values of syntax elements for picture-layer syntax for a given picture, (2) fill control structure(s) with values of control parameters for the given picture, and (3) initiate encoding of the given picture using accelerator hardware. Or, as another example, a host encoder may set the values of syntax elements for sequence-layer syntax and picture-layer syntax and then, on a slice-by-slice basis, (1) set the values of syntax elements for slice-header-layer syntax for a given slice, (2) fill control structure(s) with values of control parameters for the given slice, and (3) initiate encoding of the given slice using accelerator hardware, before repeating for the next picture in the sequence.

Before encoding begins, or even during encoding for some encoding control properties, the host encoder can set values of encoding control properties in response to one or more calls by an application across an interface exposed by the host encoder. Also, the host encoder can directly or indirectly receive feedback information (e.g., complexity information, quality information and/or bit rate information for the media) from the accelerator. Based at least in part on the feedback information, the host encoder can determine the values of rate-control parameters or other parameters.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. One or more computer-readable media storing computer-executable instructions for causing a computing system programmed thereby to perform a method comprising:
with a host encoder, setting values of encoding control properties in response to one or more calls by an application across an interface exposed by the host encoder;
with the host encoder, setting values of syntax elements of an output bitstream for at least one of sequence-layer syntax and picture-layer syntax for media;
with the host encoder, filling one or more control structures with values of control parameters; and
with the host encoder, initiating encoding of the media by an accelerator that includes accelerator hardware, wherein the one or more control structures are passed across an accelerator interface situated between the host encoder and the accelerator hardware, thereby facilitating control by the accelerator of encoding operations subject to the values of syntax elements set by the host encoder for the at least one of sequence-layer syntax and picture-layer syntax.

2. The one or more computer-readable media of claim 1 wherein the interface exposed by the host encoder includes sub-routines for setting the values of the encoding control properties and sub-routines for retrieving the values of the encoding control properties, and wherein the host encoder exposes another interface that includes sub-routines for managing input streams and sub-routines for managing output streams.

3. The one or more computer-readable media of claim 1 wherein the encoding operations controlled by the accelerator include intra-picture estimation and prediction operations, motion estimation and compensation operations, frequency transform operations, quantization operations, and entropy coding/bitstream formatting operations for lower-layer syntax for the media, and wherein, after encoding, the output bitstream includes:
a sequence parameter set syntax structure indicating the values of syntax elements set by the host encoder for sequence-layer syntax;
a picture parameter set syntax structure indicating the values of syntax elements set by the host encoder for picture-layer syntax; and
other syntax structures indicating values of syntax elements set by the accelerator for the slice-data-layer syntax and lower layers of syntax.

4. The one or more computer-readable media of claim 3 wherein, after encoding, the output bitstream further includes slice-header syntax structures indicating values of syntax elements set by the accelerator for slice-header-layer syntax, the values of syntax elements set by the accelerator for slice-header-layer syntax including values of syntax elements for reference picture list construction.

5. The one or more computer-readable media of claim 3 wherein, after encoding, the output bitstream further includes slice-header syntax structures indicating values of syntax elements set by the host encoder for slice-header-layer syntax, the values of syntax elements set by the host encoder for slice-header-layer syntax including values of syntax elements for reference picture list construction.

6. The one or more computer-readable media of claim 1 wherein the method further comprises, with the host encoder, setting values of syntax elements of the output bitstream for slice-header-layer syntax.

7. The one or more computer-readable media of claim 1 wherein the method further comprises, with the host encoder, setting values of syntax elements of the output bitstream for one or more supplemental enhancement information messages, access unit delimiters and/or other information.

8. The one or more computer-readable media of claim 1 wherein the control parameters include one or more rate-control parameters that specify targets or factors that affect quality and/or bit rate.

9. The one or more computer-readable media of claim 1 wherein the accelerator interface situated between the host encoder and the accelerator hardware includes an application programming interface and a device driver interface.

10. The one or more computer-readable media of claim 9 wherein the accelerator interface is operable to work with device drivers for any of multiple different types of accelerator hardware, and wherein the accelerator interface is operable to work with host encoders for any of multiple codec standards or formats.

11. The one or more computer-readable media of claim 1 wherein the method further comprises:
receiving, at the host encoder, feedback information from the accelerator; and
with the host encoder, determining the values of control parameters based at least in part on the feedback information.

12. The one or more computer-readable media of claim 11 wherein the feedback information includes one or more of complexity information, quality information and bit rate information for the media.

13. The one or more computer-readable media of claim 1 wherein the one or more control structures further include information indicating results of pre-processing analysis, the information including one or more of region of interest information, complexity information, noise type information, noise level information and luma sample level information.

14. In a computing system that implements a host encoder, a method comprising:
with a host encoder, setting values of syntax elements of an output bitstream for at least sequence-layer syntax and picture-layer syntax for video, wherein, after encoding, the output bitstream includes:
a sequence parameter set syntax structure indicating the values of syntax elements set by the host encoder for sequence-layer syntax; and
a picture parameter set syntax structure indicating the values of syntax elements set by the host encoder for picture-layer syntax for the video;
with the host encoder, filling one or more control structures with values of control parameters; and
with the host encoder, initiating encoding of the video by an accelerator that includes accelerator hardware, wherein the one or more control structures are passed across an accelerator interface situated between the host encoder and the accelerator hardware, thereby facilitating control by the accelerator of intra-picture estimation and prediction operations, motion estimation and compensation operations, frequency transform operations, quantization operations, and at least some entropy coding/bitstream formatting operations subject to the values of syntax elements set by the host encoder for sequence-layer syntax and picture-layer syntax, and wherein, after encoding, the output bitstream includes other syntax structures indicating values of syntax elements set by the accelerator for slice-data-layer syntax and lower layers of syntax for the video.

15. The method of claim 14 further comprising:
with the host encoder, setting values of syntax elements of the output bitstream for slice-header-layer syntax.

16. The method of claim 14 further comprising:
with the host encoder, setting values of syntax elements of the output bitstream for one or more supplemental enhancement information messages, access unit delimiters and/or other information.

17. The method of claim 14 wherein the accelerator interface situated between the host encoder and the accelerator hardware includes an application programming interface and a device driver interface between the host encoder and one or more device drivers, wherein the accelerator interface is operable to work with any of multiple device drivers for different types of accelerator hardware, and wherein the accelerator interface is operable to work with host encoders for any of multiple codec standards or formats.

18. The method of claim 14 further comprising:
receiving, at host encoder, feedback information from the accelerator, wherein the feedback information includes one or more of complexity information, quality information and bit rate information for the video; and
with the host encoder, determining the values of control parameters based at least in part on the feedback information.

19. The method of claim 14 wherein the one or more control structures further include information indicating results of pre-processing analysis, the information including one or more of region of interest information, complexity information, noise type information, noise level information and luma sample level information.

20. A computing system comprising a processor, memory and accelerator hardware, wherein the computing system implements a host encoder adapted to perform a method comprising:
with a host encoder, setting values of syntax elements of an output bitstream for at least sequence-layer syntax and picture-layer syntax for video, wherein, after encoding, the output bitstream includes:
a sequence parameter set syntax structure indicating the values of syntax elements set by the host encoder for sequence-layer syntax; and
a picture parameter set syntax structure indicating the values of syntax elements set by the host encoder for picture-layer syntax for the video;
with the host encoder, filling one or more control structures with values of control parameters; and
with the host encoder, initiating encoding of the video by an accelerator that includes accelerator hardware, wherein the one or more control structures are passed across an accelerator interface situated between the host encoder and the accelerator hardware, thereby facilitating control by the accelerator of intra-picture estimation and prediction operations, motion estimation and compensation operations, frequency transform operations, quantization operations, and at least some entropy coding/bitstream formatting operations subject to the values of syntax elements set by the host encoder for sequence-layer syntax and picture-layer syntax, and wherein, after encoding, the output bitstream includes other syntax structures indicating values of syntax elements set by the accelerator for slice-data-layer syntax and lower layers of syntax for the video.
